(19) United States
(12) Patent Application Publication
(10) Pub. No.: US 2005/0286857 A1
(43) Pub. Date: Dec. 29, 2005

(54) Method and system for controlling broadcast recorder

(76) Inventor: Janne Kallio, Pattijoki (FI)

Correspondence Address: Hollingsworth & Funk, LLC, Suite 125, 8009 34th Avenue South, Minneapolis, MN, 55425, US

(21) Appl. No.: 10/881,498

(22) Filed: Jun. 29, 2004

(51) Int. Cl. H04N 5/76

(52) U.S. Cl. 386/46; 386/83

(57) ABSTRACT

A mobile terminal, a broadcast recorder, a system, a computer program distribution medium, and a method of operating a broadcast recorder are disclosed. In the method, control information is written into a broadcast recorder control object having object type identification based on which the broadcast recorder control object is identifiable from a plurality of objects, the control information including instructions for executing at least one command in a broadcast recorder; the broadcast recorder control object is communicated to a broadcast recorder by using a wireless connection; the object type identification is detected; the control information is extracted from the broadcast recorder control object on the basis of the object type identification; and the at least one command is executed in the broadcast recorder according to instructions included by the control information.

### FIELD

The invention relates to a method of operating a broadcast recorder, a mobile terminal, a broadcast recorder, a system for operating a broadcast recorder, and a computer program distribution medium.

### BACKGROUND

Broadcast recorders, such as personal video recorders, are typically operated with device-specific infrared remote control equipment that typically transmits individual commands and/or characters to the broadcast recorder. For example, programming of a broadcast recorder to carry out a scheduled recording requires a sequence of program numbers and commands to be dialed into the device-specific infrared remote control equipment and transmitted to the broadcast recorder over an infrared link. The user typically reads the programming information from a printed matter or other distribution means, and monitors the programming from a TV screen.

The use of device-specific infrared remote control equipment is laborious and requires a dedicated remote control unit for controlling the broadcast recorder. Therefore, it is desirable to consider improvements for operating a broadcast recorder.

### BRIEF DESCRIPTION OF THE INVENTION

An object of the invention is to provide an improved method, mobile terminal, broadcast recorder, system, and computer program distribution medium.

According to a first aspect of the invention, there is provided a method of operating a broadcast recorder, comprising: writing control information into a broadcast recorder control object having object type identification based on which the broadcast recorder control object is identifiable from a plurality of objects, the control information including instructions for executing at least one command in a broadcast recorder; communicating the broadcast recorder control object to a broadcast recorder by using a wireless connection; detecting the object type identification; extracting the control information from the broadcast recorder control object on the basis of the object type identification; and executing the at least one command in the broadcast recorder according to the instructions included by the control information.

According to a second aspect of the invention, there is provided a mobile terminal of a wireless telecommunications system, comprising: a broadcast recorder control object having object type identification based on which the broadcast recorder control object is identifiable from a plurality of objects; writing means for writing control information into the broadcast recorder control object, the control information including instructions for executing at least one command in a broadcast recorder; and communicating means for communicating the broadcast recorder control object to the broadcast recorder by using a wireless connection.

According to a third aspect of the invention, there is provided a broadcast recorder comprising: communicating means for communicating a broadcast recorder control object by using a wireless connection, the broadcast recorder control object having object type identification based on which the broadcast recorder control object is identifiable from a plurality of objects, the broadcast recorder control object including control information which includes instructions for executing at least one command; detecting means for detecting the object type identification; extracting means for extracting the control information from the broadcast recorder control object on the basis of the object type identification; and executing means for executing the at least one command according to the instructions included by the control information.

According to a fourth aspect of the invention, there is provided a system for operating a broadcast recorder, comprising: a mobile terminal of a wireless telecommunications system, the mobile terminal including: a broadcast recorder control object having object type identification based on which the broadcast recorder control object is identifiable from a plurality of objects; writing means for writing control information into the broadcast recorder control object, the control information including instructions for executing at least one command in a broadcast recorder; and first communicating means for communicating the broadcast recorder control object to the broadcast recorder by using a wireless connection, the system further comprising a broadcast recorder including: second communicating means for communicating the broadcast recorder control object by using a wireless connection; detecting means for detecting the object type identification; extracting means for extracting the control information from the broadcast recorder control object on the basis of the object type identification; and executing means for executing the at least one command according to the instructions included by the control information.

According to yet another aspect of the invention, there is provided a computer program distribution medium readable by a computer and encoding a computer program of instructions for executing a computer process for operating a broadcast recorder, the process comprising: writing control information into a broadcast recorder control object having object type identification based on which the broadcast recorder control object is identifiable from a plurality of objects, the control information including instructions for executing at least one command in a broadcast recorder; communicating the broadcast recorder control object to the broadcast recorder by using a wireless connection; detecting the object type identification; extracting the control information from the broadcast recorder control object on the basis of the object type identification; and executing the at least one command in the broadcast recorder according to the instructions included by the control information.

The invention enables mobile terminal resources, such as wireless interface and data structures, to be used for controlling a broadcast recorder, thus simplifying remote operation of a broadcast recorder.

### LIST OF DRAWINGS

In the following, the invention will be described in greater detail with reference to embodiments and the accompanying drawings, in which

FIG. 1 shows an example of a structure of a system for operating a broadcast recorder;

FIG. 2 shows an example of a data structure of a broadcast recorder control object;

FIG. 3 illustrates an example of a structure of a broadcast recorder;

FIG. 4 illustrates an example of a structure of a mobile terminal;

FIG. 5 shows a first example of a methodology according to embodiments of the invention;

FIG. 6 shows a second example of a methodology according to embodiments of the invention; and

FIG. 7 shows another example of a methodology according to embodiments of the invention.

### DESCRIPTION OF EMBODIMENTS

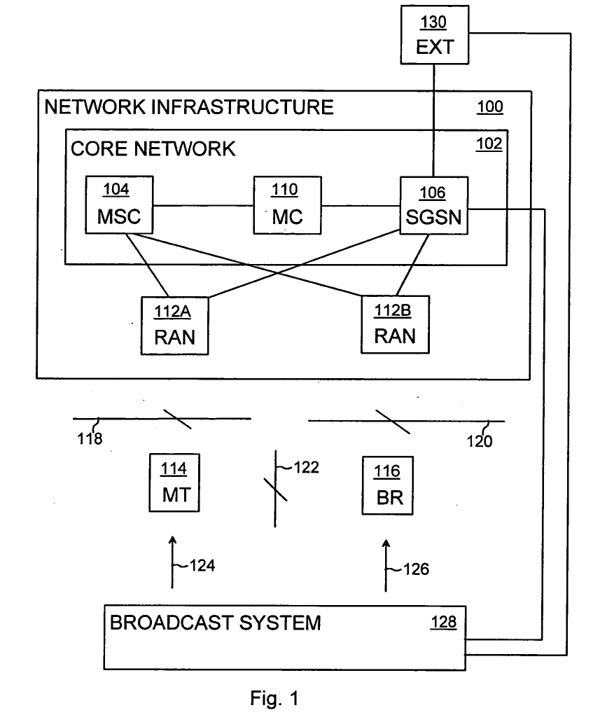

FIG. 1 shows a mobile terminal (MT) 114, a broadcast recorder (BR) 116, a broadcast system 128, a telecommunications system infrastructure 100, and external networks (EXT) 130, such as the Internet and/or a PLMN (Public Land Mobile Network).

The network infrastructure 100 comprises a core network 102 that includes exchanges, such as a mobile services switching center 104 (MSC) and a serving GPRS support node 106 (SGSN). The MSC 104 and the SGSN 106 provide switching resources in a circuit-switched domain and a packet-switched domain, respectively, of the telecommunications system. The core network 102 may include elements excluded from FIG. 1, such as those providing gateways between the external networks 130 and exchanges of the core network 102.

The network infrastructure 100 further comprises radio access networks (RAN) 112A, 112B. The radio access network 112A, 112B provides a radio interface 118 between the network infrastructure 100 and the mobile terminal 114. In an embodiment of the invention, the radio access network 112A, 112B further provides a radio interface 120 for the broadcast recorder 116. In such a case, the mobile terminal 114 may communicate broadcast recorder control objects with the broadcast recorder 116 over the network infrastructure 100.

The broadcast recorder control object is a data stream that includes control information comprising instructions for executing at least one command in the broadcast recorder 116. The broadcast recorder 116 may be operated wirelessly by generating the broadcast recorder control object in the mobile terminal 114 and by delivering the broadcast recorder control object to the broadcast recorder 116.

The network infrastructure 100 may further comprise a message center 110 (MC), herein also referred to as a telecommunications system server, for transferring broadcast recorder control objects between the mobile terminal 114 and the broadcast recorder 116. The message center 110 may receive and store broadcast recorder control objects transmitted by the mobile terminal 114 and further bypass the broadcast recorder control object to the broadcast recorder 116.

In an embodiment of the invention, the message center 110 receives and stores a broadcast recorder control object transmitted by the broadcast recorder 116. The message center 110 may transmit the broadcast recorder control object to the mobile terminal 114.

In an embodiment of the invention, the broadcast recorder control object is delivered by using a short messaging service (SMS). In such a case, the message center 110 is a SMS center.

In another embodiment, the broadcast recorder control object is delivered by using a multimedia messaging service (MMS). In such a case, the message center 110 is a MMS center.

The telecommunications system may apply one or more radio access technologies, such as GSM (Global System for Mobile Communications), GERAN (GSM/EDGE Radio access network), GPRS (General Packet Radio Service), E-GPRS (EDGE GPRS), UMTS (Universal Mobile Telecommunications System), CDMA2000 (CDMA, Code Division Multiple Access), US-TDMA (US Time Division Multiple Access), MC-GDMA (Multi-Carrier Code Division Multiple Access) and/or OFDMA (Orthogonal Frequency Division Multiple Access) technologies, the present solution not being, however, limited to these radio access technologies. In some applications, the telecommunications system may include network elements supporting Wireless Local Area Network (WLAN) terminals. It is presumed that the structure and operation of relevant radio access technologies and associated network elements are known to one skilled in the art.

FIG. 1 further shows a wireless proximity interface 122 that provides a wireless proximity connection between the mobile terminal 114 and the broadcast recorder 116. The wireless proximity interface 122 may support a standardized object exchange protocol, such as an OBEX (Object Exchange Protocol) and may be implemented with infrared technology and/or proximity radio technology, such as a Bluetooth technology.

In an embodiment of the invention, broadcast recorder control objects are communicated over the wireless proximity connection 112 by using the standardized object exchange protocol.

FIG. 1 further shows a broadcast system 128 that may be provided under digital systems, such as Digital Video Broadcast (DVB) and/or Advanced Television Systems Committee (ATSC). The broadcast system is not, however, restricted to digital broadcasting, but may be applied to analog broadcasting systems, such as PAL (Phase Alteration by Line) and/or NTSC (The National Television System Committee).

In an embodiment of the invention, the broadcast system 128 further broadcasts radio signals. The radio signals may deliver radio programs to the broadcast recorder 116. The radio signals may further contain data provided by RDS (Radio Data System), for example.

The broadcast system 128 generates broadcast signals 126 including broadcast programs, such as TV programs and/or radio programs.

In an embodiment of the invention, the broadcast signal 126 includes program information, i.e. an electronic program guide (EPG), on broadcast programs being broadcast and/or to be broadcast by the broadcast system 128.

The broadcast signal 126 may be broadcast wirelessly using, for example, satellites or terrestrial radio links. The broadcast signal 126 may also be transmitted over a cable network to which the broadcast recorder 116 is connected.

In an embodiment of the invention, the broadcast system 128 generates a mobile terminal broadcast signal 124 that may be received by the mobile terminal 114. In such a case, the mobile terminal broadcast signal 124 is typically a digital signal and formatted according to the requirements of the mobile terminal 114. The mobile terminal broadcast signal 126 may include program information on broadcast programs being broadcast and/or to be broadcast on the broadcast signal 126.

The broadcast system 128 may further be connected to the external networks 130 and/or a core network element, such as the SGSN 106, via which a portion of the broadcast transmission and/or program information may be provided to the mobile terminal 114 and/or the broadcast recorder 116.

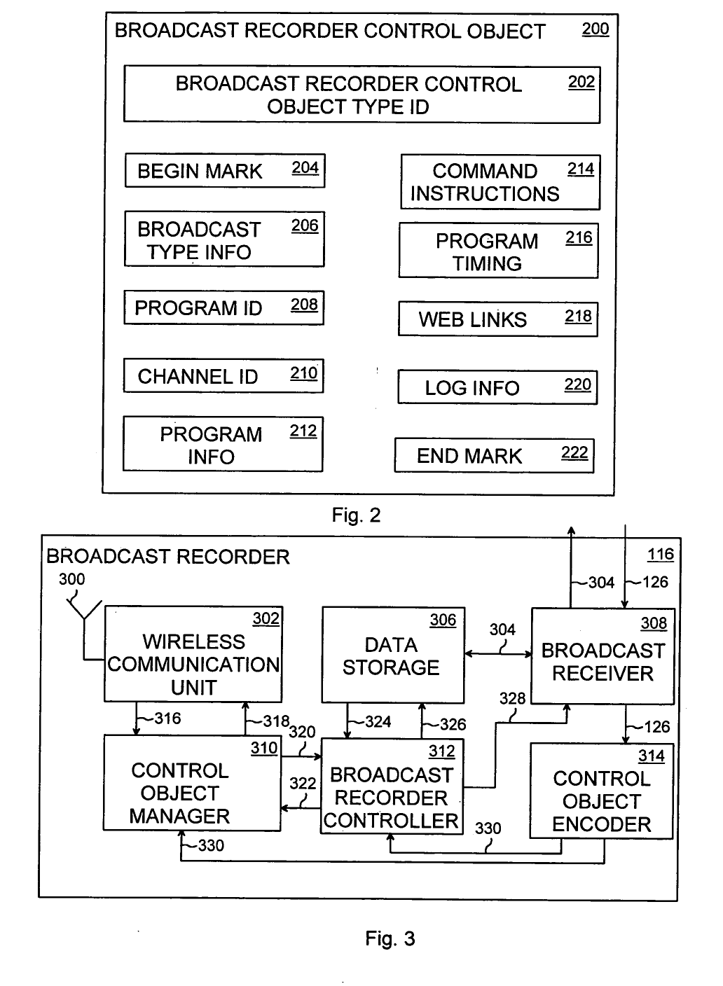

FIG. 2 illustrates an example of the data structure of a broadcast recorder control object 200. A broadcast recorder control object 200 is typically a data structure having object type identification 202 based on which the broadcast recorder control object 200 is identifiable from other objects, such as visitor card objects, calendar objects, note objects, and/or message objects.

In an embodiment of the invention, the broadcast recorder control object type identification 202 is provided by a file identifier of the broadcast recorder control object 200. The file identifier may be of the type “filename.extension” where the extension may define the file as a broadcast recorder control object 200. The extension may be “vco”, for example. The filename may also specify the broadcast recorder control object 200.

FIG. 2 further shows broadcast recorder control object elements 204 to 222 hereby referred to as control elements. At least some of the control elements are included in broadcast recorder control information, also referred to as control information.

Control elements “BEGIN MARK” 204 and “END MARK” 222 indicate the first item and the last item, respectively, of the broadcast recorder control object 200. Other control elements are listed between the “BEGIN MARK” 204 and the “END MARK” 222.

A control element “BROADCAST TYPE INFO” 206 typically specifies a broadcast type. A broadcast type may be, for example, a DVB-T (Digital Video Broadcasting-Terrestrial), DVB-S (Digital Video Broadcasting-Satellite), DVB-C (Digital Video Broadcasting-Cable), DVB-H (Digital Video Broadcasting-Handheld), DAB (Digital Audio Broadcasting), or analog broadcasting.

A control element “CHANNEL ID” 210 typically specifies a broadcast channel, such as a channel number, on which the broadcast program is broadcast.

A control element “PROGRAM INFO” 212 provides general information, such as a classification of the broadcast program, a title of the broadcast program, and/or a description of the broadcast program. The classification may be a movie, a documentary, and/or sports, for example.

A control element “COMMAND INSTRUCTIONS” 214 includes instructions for the broadcast recorder 116 to execute commands. An instruction “PLAY” may indicate a “PLAY” command to be executed in the broadcast recorder 116, thus switching on a playback of a recording in the broadcast recorder 116. An instruction “RECORD” may trigger a recording of a broadcast program specified by other control elements 206 to 216. An instruction “STATUS” may instruct the broadcast recorder 116 to generate status information, such as a present programming state and storage space, and to transmit the status information to the mobile terminal 114. The present solution is not, however, restricted to these instructions, but the broadcast recorder 116 may be instructed to execute any broadcast recorder command by using the “COMMAND INSTRUCTIONS” control element 214.

A control element “PROGRAM TIMING” 216 specifies the timing of executing the commands specified by the “COMMAND INSTRUCTIONS” control element 214. For example, the “PROGRAM TIMING” 216 specifies the time for executing a “RECORD” command and the time for executing a “STOP” command canceling the current command. The “PROGRAM TIMING” 216 may further specify the duration of the broadcast program.

A control element “WEB LINKS” 218 may include links to web sites associated with the broadcast program.

A control element “PROGRAM ID” 208 provides a unique identification for the broadcast program. The unique identification may provide a logical link to other broadcast program information, such as those specified by control elements 206, 210, 212, 216, 218. In an embodiment of the invention, the “PROGRAM ID” specifies a ShowView code or another known programming code associated with the broadcast program.

A control element “LOG INFO” 220 may include file history of the broadcast recorder control object 200. The file history may comprise the time of creation of the broadcast recorder control object 200 and the time of modification of the broadcast recorder control object 200.

In an embodiment of the invention, the broadcast recorder control object type identification 202 is specified in a control element.

The control elements 202 to 222 may be identified in the broadcast recorder control object 200 by a string of characters. A general format may be “control_element specifier:value_of_control_element_specifier”, where the string “control_element_specifier” specifies the function of the control element 202 to 222. The string “value_of_control_element_specifier” specifies the value of the string “control_element_specifier” The “control_element_specifier” may equal “instructiontype” and the “value_of_control_element specifier” may equal “record”, thus indicating a recording instruction.

A broadcast control object file and associated mobile-terminal-specific and/or broadcast-recorder-specific configuration parameters for providing a broadcast recorder object capability may be provided as default features in the mobile terminal 114 and the broadcast recorder 116. They may also be available from a telecommunications system operator and/or a mobile phone vendor.

FIG. 3 shows a broadcast recorder 116 including a wireless communication unit 302 with an antenna 300, a broadcast receiver 308, a data storage 306, a broadcast recorder controller 312, a control object manager 310, and a control object encoder 314.

The broadcast receiver 308 provides hardware and software for receiving broadcast signals 126 and extracting a broadcast program data stream 304 from the broadcast signals 126. The structure and operation of a broadcast receivers are known to a skilled person and only details relevant to the present solution are discussed in further detail.

The broadcast receiver 308 may output the broadcast program data stream 304 into a monitoring unit, such as an audiovisual system, not shown in FIG. 3.

In an embodiment of the invention, the broadcast receiver 308 outputs the broadcast program data stream 304 into the data storage 306. The data storage 306 may include a mass memory, such as a magnetic tape, a hard drive, a read-write digital versatile disc (DVD), or other storage means for storing an extensive amount of digital data. The data storage 306 may include physical storage means and an internal controller for controlling the operation of the data storage 306.

The broadcast receiver 308 may further be capable of retrieving previously recorded broadcast program data from the data storage 306 and play the broadcast program data stream 304 on the monitor unit.

The data storage 306 and the broadcast receiver 308 may be controlled by a broadcast recorder controller 312. The broadcast recorder controller 312 may input a receiver instruction signal 328 into the broadcast receiver 308. The receiver instruction signal 328 may include control information included in the broadcast recorder control object. Such control information may include, for example, a channel number, a broadcast type identification, and command instructions. The command instructions may define, for example, whether the broadcast program data stream 304 is played or recorded.

The broadcast recorder controller 312 may input a storage instruction signal 326 into the data storage 306. The storage instruction signal 326 may instruct the data storage 306 to initiate a recording of the broadcast program data stream 304. The storage instruction signal 326 may further give rise to a deletion of data from the data storage 306 in order to provide storage space for the broadcast program data stream 304. The instruction for deleting data may be included in the broadcast recorder control object 200.

The broadcast recorder controller 312 may further receive a data storage monitor signal 324 from the data storage 306. The data storage monitor signal 324 may provide status information, such as available capacity, on the data storage 306. A portion of the status information may be included in the broadcast recorder control object 200.

In an embodiment of the invention, the broadcast recorder controller 312 generates status information 322, such as that regarding storage space of the data storage 306 and the present programming instructions, on the state of the broadcast recorder 116 and inputs the status information into the control object manager 310. At least a portion of the status information may be written into the broadcast recorder control object 200 and transmitted to the mobile terminal 114.

The broadcast recorder controller 312 may be implemented with a digital processor and memory of the broadcast recorder 116. Some functionalities may be implemented with ASICs (Application Specific Integrated Circuit).

The control object manager 310 receives a data stream 316 from the wireless communication unit 302 and detects the object type identification 202 from the data stream 316. A correct identification of the data stream 316 indicates that the data stream 316 includes the broadcast recorder control object 200. The object type identification 202 associates the received object with the data structure of the broadcast recorder control object 200.

The data structure and object type identification of the broadcast recorder control object 200 are known a priori to the control object manager 310 on the basis of, for example, the broadcast-recorder-specific configuration parameters, thus enabling the control object manager 310 to read and unambiguously interpret the control elements 202 to 222 from the broadcast recorder control object 200.

The control object manager 310 inputs a control signal 320 into the broadcast recorder controller 312. The control signal 320 includes the contents of at least some control elements 202 to 222. The broadcast recorder controller 312 generates the instruction signals 326 and 328 according to the control elements 202 to 222.

The control object manager 310 may include a plurality of broadcast recorder control objects 200 transmitted from the mobile terminal 114, each broadcast recorder control object 200 corresponding to one broadcast program. The broadcast recorder control objects 200 corresponding to different broadcast programs may be separated from one another by different file names. Furthermore, broadcast recorder control objects 200 may be located in different directories in the control object manager 310 according to the status of the broadcast recorder control objects 200. Such a status may be new, current, and/or executed.

In an embodiment of the invention, the broadcast recorder 116 includes a control object decoder 314 for decoding control information 330 from the broadcast signal 126. The control information 330 may be delivered to the control object manager 310 which writes the control information 330 into the broadcast recorder control object 200. The control object manager 310 generates a transmission data stream 318 that includes the broadcast recorder control object 200 and inputs the transmission data stream 318 into the wireless communication unit 302.

In an embodiment of the invention, the broadcast recorder controller 312 receives control information 330 from the control object decoder 314, compares the control information 330 with an instruction obtained from the broadcast recorder control object 200, and executes commands on the basis of the comparison. For example, a program identification number and an instruction to record a corresponding broadcast program are provided to the broadcast recorder controller 312 in the broadcast recorder control object 200, but the channel identification and other information required to run the actual recording are not available. In such a case, the broadcast recorder controller 312 may identify the program identification number from the control information 330 and save the channel identification and other information for later use. This procedure may be carried out in the control object manager 310, and the channel identification and other information may be written into the broadcast recorder control object 200.

The broadcast recorder control object 200 may be provided to the mobile terminal 114 as a response to a request for the broadcast recorder control object 200.

The wireless communication unit 302 provides wireless transmission and reception of signals carrying broadcast recorder control objects 200. In some applications, the wireless communication unit 302 acts as a server/client with respect to the mobile terminal 114.

In an embodiment of the invention, the wireless communication unit 302 includes a radio modem supporting at least one radio access technology applied by the telecommunications system, thus enabling the wireless communication unit 302 to connect to the network infrastructure 100.

The structure and operation of radio modems are known to one skilled in the art, and they will not be discussed in greater detail in this context.

In another embodiment of the invention, the wireless communication unit 302 includes a proximity radio transceiver providing a proximity radio connection to the mobile terminal 114. The proximity radio transceiver 302 may further support standardized object exchange protocols, such as the OBEX. Such a radio transceiver may be based on the Bluetooth technology, for example.

In another embodiment of the invention, the wireless communication unit 302 includes an infrared transceiver providing an optical link to the mobile terminal 114. Such a case, the infrared transceiver may support a standardized object exchange protocol, such as the OBEX. The optical link may further comply with standards, such as that defined by an Infrared Mobile Communications (IrMC) specification.

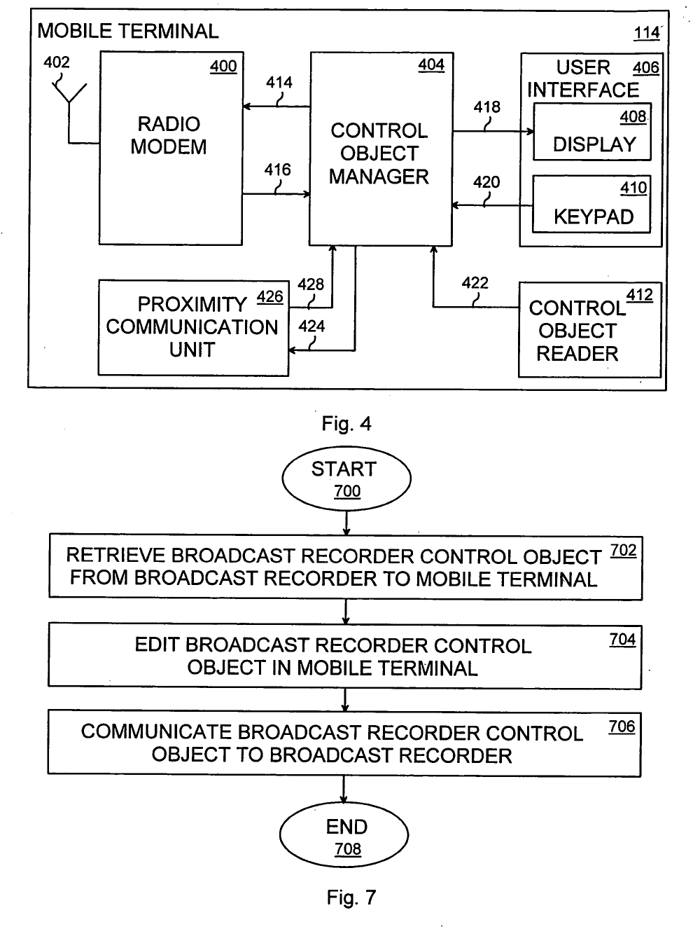

FIG. 4 shows a mobile terminal 114 including a radio modem 400 with an antenna 402, a control object manager 404, a proximity communication unit 426, a control object reader 412, and a user interface 406.

The radio modem 400 implements the radio interface 118 between the network infrastructure 100 and the mobile terminal 114. The radio modem 400 may support at least one radio access technology applied by the telecommunications system. The structure and operation of radio modems are known to one skilled in the art, and they will not be discussed in greater detail in this context.

The proximity communication unit 426 implements the wireless proximity interface 122 between the mobile terminal 114 and the broadcast recorder 116. The wireless proximity interface 122 may further implement a wireless proximity interface between the mobile terminal 114 and other mobile terminals. The broadcast recorder control objects 200 may be exchanged between the mobile terminal 114 and other mobile terminals by using the wireless proximity interface and/or the network infrastructure 100.

The proximity communication unit 426 may receive the broadcast recorder control object 200 over the proximity interface 122 and input a signal 428 including at least a portion the contents of the broadcast recorder control object 200 into the control object manager 404.

In an embodiment of the invention, the proximity communication unit 426 receives a signal 424 that includes the broadcast recorder control object 200 and transmits the broadcast recorder control object 200 to the broadcast recorder 116 over the proximity interface 122.

In another embodiment of the invention, the radio modem 400 receives a signal 414 that includes the broadcast recorder control object 200 and transmits the broadcast recorder control object 200 to the broadcast recorder 116 via the telecommunications system server 110.

In an embodiment of the invention, the proximity communication unit 426 includes a proximity radio transceiver providing a proximity radio connection to the broadcast recorder 116 and to other mobile terminals. The proximity radio transceiver may further support standardized object exchange protocols, such as the OBEX. Such a radio transceiver may be based on the Bluetooth technology, for example.

In another embodiment of the invention, the proximity communication unit 426 includes an infrared transceiver providing an optical link to the broadcast recorder 116 and to other mobile terminals. In this case, the infrared transceiver may support a standardized object exchange protocol, such as the OBEX. The optical link may further comply with standards, such as that defined by an Infrared Mobile Communications (IrMC) specification.

The control object manager 404 may include a broadcast recorder control object 200 into which control information, i.e. the values of the control elements, is written.

In an embodiment of the invention, the broadcast recorder control object 200 is obtained from a server located in the network infrastructure 100 and/or the external networks 130. The mobile terminal 114 may connect to the server by using an IP (Internet Protocol) address of the server and retrieve a portion of the contents of the broadcast recorder control object 200 or the broadcast recorder control object 200 from the server. The mobile terminal 116 may be provided with software and/or a browser for connecting to the server to alleviate the establishment of the connection. The user may write command instructions into the broadcast recorder control object 200 and transmit the broadcast recorder control object 200 to the broadcast recorder 116.

In an embodiment of the invention, a signal 418 delivering a portion of the broadcast recorder control object 200 is inputted into a display 408 of the user interface 406. The display 408 displays the portion of the broadcast recorder control object 200 into which the user of the mobile terminal 114 may dial values of the control elements 202 to 222 by using a keypad 410 or another input device. The keypad 410 generates an input signal 420 accordingly and updates the broadcast recorder control object 200 with a new value of the control element. The user may dial, for example, the value of the “PROGRAM ID” control element 208. The broadcast recorder control object 200 with an updated value of the control element is saved and outputted to the radio modem 400 or to the proximity communication unit 426 to be delivered to the broadcast recorder 116. The broadcast recorder 116 receives the updated broadcast recorder control object 200 and executes commands specified by the broadcast recorder control object 200.

The control object manager 404 may be implemented with a digital processor of the mobile terminal 114 as a software application.

In an embodiment of the invention, the control information 416 is received over the wireless connection from the network infrastructure 100, another mobile terminal, the broadcast recorder 114, and/or from the broadcast system 128. In such a case, the user may be provided with a plurality of broadcast recorder control objects 200, each corresponding to a broadcast program. Such a case, each broadcast recorder control object 200 may include updated control elements, such as the “BROADCAST TYPE INFO” 206, “PROGRAM INFO” 212, “PROGRAM TIMING” 216, “WEB LINKS” 218, and “PROGRAM ID” 208. The user may enter a value for the “COMMAND INSTRUCTIONS” control element 214 and send the full broadcast recorder control object 200 to the broadcast recorder 116.

In another embodiment of the invention, the control object reader 412 reads control information 422 from an optically readable medium by using bar codes, for example. A bar code may include a program identification number delivered to the control object manager 404. The control object manager 404 may update the broadcast recorder control object 200 with the program identification number and display the broadcast recorder control object 200 to the user. The user may dial the command instructions, such as “RECORD”, and transmit the broadcast recorder control object 200 to the broadcast recorder 116. Dialing of the command instructions may also be carried out by selecting a suitable menu item, such as a “PLAY” command, from a group of menu items shown to the user by the display 408.

In an embodiment of the invention, the control object reader 412 reads control information 422 electrically from a printed matter on which the control information is encoded as an electrically readable ink pattern. The printed matter may be, for example, a newspaper or a program guide. The electrically readable ink pattern may include full information on a broadcast program. The control object manager 404 may update the broadcast recorder control object 200 with the control information and display the broadcast recorder control object 200 to the user. The user may dial the command instructions, such as “RECORD”, and transmit the broadcast recorder control object 200 to the broadcast recorder 116.

The standardized object exchange protocols, such as the OBEX, support various protocol levels, each level having characteristics of its own. The protocols typically define a server and a client according to the hierarchy of the devices communicating over the protocol.

In an embodiment of the invention, the broadcast recorder 116 is the server and the mobile terminal 114 is the client. In such a case, the mobile terminal 114 may virtually monitor and modify broadcast recorder control objects 200 located in the broadcast recorder 116. In practice this may be carried out by retrieving the broadcast recorder control object 200 from the broadcast recorder 116 to the mobile terminal 114, editing the broadcast recorder control object in the mobile terminal 114, and communicating the broadcast recorder control object 200 back to the broadcast recorder 116.

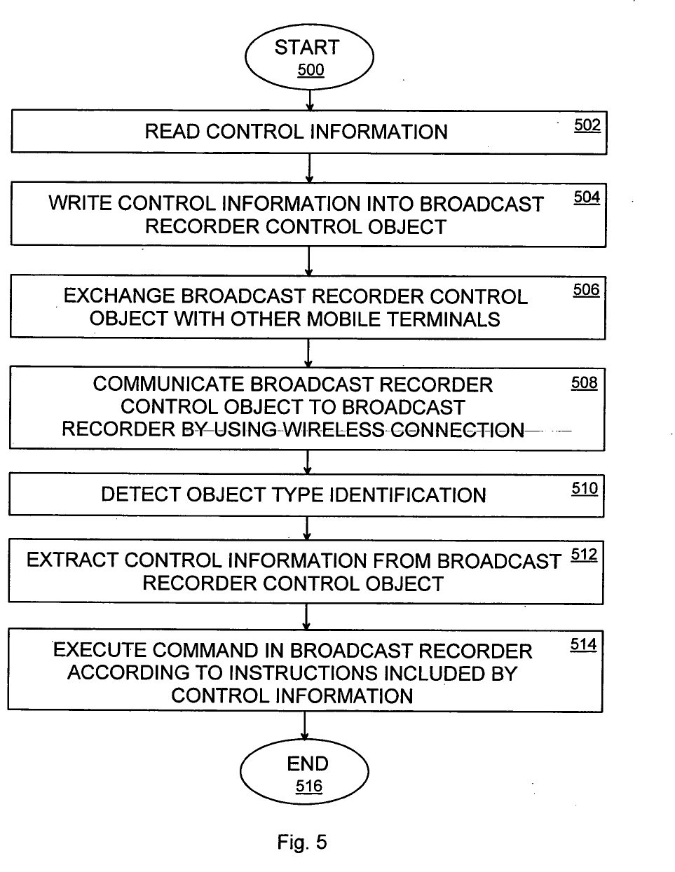

With reference to FIGS. 5, 6 and 7, examples of methodologies according to embodiments of the invention are illustrated with flow charts.

With reference to FIG. 5, the method starts in 500.

In 502, control information is read. In an embodiment of the invention, the control information is read from at least one component selected from a list comprising: an optically readable medium, an electrically readable medium, user dialing. In another embodiment of the invention, the control information is read electrically from a printed matter, the control information is encoded on a printed matter as an electrically readable ink pattern.

In 504, control information is written in the mobile terminal 114 into a broadcast recorder control object 200 having object type identification 202 based on which the broadcast recorder control object 200 is identifiable from a plurality of objects, the control information including instructions for executing at least one command in a broadcast recorder 116.

In 506, according to an embodiment, the broadcast recorder control object 200 is exchanged with other mobile terminals by using an object exchange protocol.

In 508, the broadcast recorder control object 200 is communicated to the broadcast recorder 116 by using a wireless connection.

In 510, the object type identification 202 is detected.

In 512, the control information is extracted from the broadcast recorder control object 200 on the basis of the object type identification 202.

In 514, at least one command is executed in the broadcast recorder 116 according to the instructions included by the control information.

In 516, the method ends.

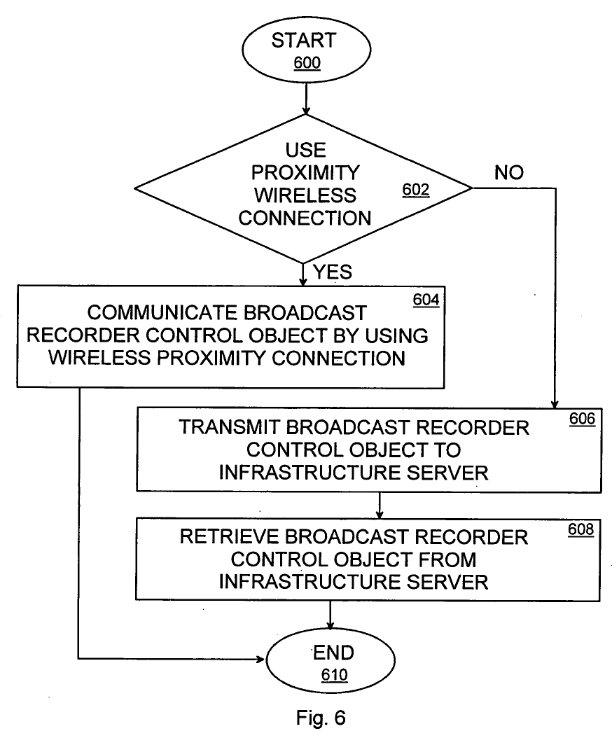

With reference to FIG. 6, the method starts in 600.

In 602, a selection is made between the proximity wireless connection and the network infrastructure 100 to communicate the broadcast recorder control object 200.

In 604, according to an embodiment, the broadcast recorder control object 200 is communicated over the wireless proximity connection 122 between the mobile terminal 114 and the broadcast recorder 116 by using a standardized object exchange protocol.

In 606, according to an embodiment, the broadcast recorder control object 200 is transmitted to a telecommunications system server 110, and in 608, the broadcast recorder control object 200 is retrieved from the telecommunications system server 110.

In 610, the method ends.

With reference to FIG. 7, the method starts in 700.

In 702, according to an embodiment, the broadcast recorder control object 200 is retrieved from the broadcast recorder 116 to the mobile terminal 114, and in 704, the broadcast recorder control object 200 is edited in the mobile terminal 114.

In 706, the broadcast recorder control object 200 is communicated to the broadcast recorder 116 by using the wireless connection.

In 708, the method ends.

In an aspect, the invention provides a computer program product embodied on a computer readable distribution medium, such as a computer readable medium, a program storage medium, a record medium, a computer readable memory, a computer readable software distribution package, a computer readable signal, a computer readable telecommunications signal, and a computer readable compressed software package.

The computer program product encodes a computer program of instructions for executing a computer process including instructions for executing a computer process whose embodiments are shown in FIGS. 5, 6 and 7.

The computer program may be provided as a computer program package that may include components in the mobile terminal 114 or in the broadcast recorder 116, or both in the mobile terminal 114 and the broadcast recorder 116.

As regards the mobile terminal 114, parts of the program package may be executed in the digital processor of the radio modem 400 and/or in the digital processor of the mobile terminal 114. Parts of the program package may be stored in the memory unit of the mobile terminal 114.

As regards the broadcast recorder 116, parts of the program package may be executed in the digital processor of the wireless communication unit 302 and/or in the digital processor of broadcast recorder 116. Parts of the program package may be stored in the memory unit, such as the data storage 306, of the broadcast recorder 116.

Even though the invention has been described above with reference to an example according to the accompanying drawings, it is clear that the invention is not restricted thereto but it can be modified in several ways within the scope of the appended claims.

1. A method of operating a broadcast recorder, comprising:
writing control information into a broadcast recorder control object having object type identification based on which the broadcast recorder control object is identifiable from a plurality of objects, the control information including instructions for executing at least one command in a broadcast recorder;
communicating the broadcast recorder control object to a broadcast recorder by using a wireless connection;
detecting the object type identification;
extracting the control information from the broadcast recorder control object on the basis of the object type identification; and
executing the at least one command in the broadcast recorder according to the instructions included by the control information.

2. The method of claim 1, wherein communicating the broadcast recorder control object includes communicating the broadcast recorder control object over a wireless proximity connection between a mobile terminal and the broadcast recorder by using a standardized object exchange protocol.

3. The method of claim 1, wherein communicating the broadcast recorder control object includes:
transmitting the broadcast recorder control object to a telecommunications system server; and
retrieving the broadcast recorder control object from the telecommunications system server.

4. The method of claim 1, further comprising reading the control information from at least one component selected from a list comprising: an optically readable medium, an electrically readable medium, user dialing.

5. The method of claim 1, further comprising reading, electrically, the control information from a printed matter, the control information being encoded on the printed matter as an electrically readable ink pattern.

6. The method of claim 1, further comprising exchanging the broadcast recorder control object with other mobile terminals by using a standardized object exchange protocol.

7. The method of claim 1, further comprising:
retrieving the broadcast recorder control object from the broadcast recorder to the mobile terminal; and
editing the broadcast recorder control object in the mobile terminal; and
communicating the broadcast recorder control object to the broadcast recorder by using a wireless connection.

8. The method of claim 1, wherein the broadcast control object further includes at least one element in a group comprising: a begin mark of the broadcast recorder control object, broadcast type information, a broadcast program identifier, a broadcast channel identifier, broadcast program information, broadcast program timing information, a link to data networks, file history of the broadcast control object, an end mark of the broadcast control object.

9. A mobile terminal of a wireless telecommunications system, comprising:
a broadcast recorder control object having object type identification based on which the broadcast recorder control object is identifiable from a plurality of objects;
writing means for writing control information into the broadcast recorder control object, the control information including instructions for executing at least one command in a broadcast recorder; and
communicating means for communicating the broadcast recorder control object to the broadcast recorder by using a wireless connection.

10. The mobile terminal of claim 9, wherein the communicating means is configured to provide a wireless proximity connection to the broadcast recorder and to support a standardized object exchange protocol; and
wherein the communicating means is configured to communicate the broadcast recorder control object over the wireless proximity connection by using the standardized object exchange protocol.

11. The mobile terminal of claim 9, wherein the communicating means is configured to provide a telecommunications system radio connection to a telecommunications system infrastructure; and
wherein the communicating means is configured to communicate the broadcast recorder control object with a telecommunications system server.

12. The mobile terminal of claim 9, further comprising first reading means for reading the control information from at least one component selected from a list comprising: an optically readable medium, an electrically readable medium, user dialing.

13. The mobile terminal of claim 9, further comprising second reading means for reading, electrically, the control information from a printed matter, the control information encoded on the printed matter as an electrically readable ink pattern.

14. The mobile terminal of claim 9, further comprising exchanging means for exchanging the broadcast recorder control object with other mobile terminals by using an object exchange protocol.

15. The mobile terminal of claim 9, further comprising retrieving means for retrieving the broadcast recorder control object from the broadcast recorder to the mobile terminal; and
editing means for editing the broadcast recorder control object in the mobile terminal; and
the communicating means is configured to communicate the broadcast recorder control object to the broadcast recorder by using a wireless connection.

16. The mobile terminal of claim 9, wherein the broadcast control object includes at least one element in a group comprising: a begin mark of the broadcast recorder control object, broadcast type information, a broadcast program identifier, a broadcast channel identifier, broadcast program information, broadcast program timing information, a link to data networks, file history of the broadcast control object, an end mark of the broadcast control object.

17. A broadcast recorder comprising:
communicating means for communicating a broadcast recorder control object by using a wireless connection, the broadcast recorder control object having object type identification based on which the broadcast recorder control object is identifiable from a plurality of objects, the broadcast recorder control object including control information which includes instructions for executing at least one command;
detecting means for detecting the object type identification;
extracting means for extracting the control information from the broadcast recorder control object on the basis of the object type identification; and
executing means for executing the at least one command according to the instructions included by the control information.

18. The broadcast recorder of claim 17, wherein the communicating means is configured to provide a wireless proximity connection to a mobile terminal and to support a standardized object exchange protocol; and
wherein the communicating means is configured to communicate the broadcast recorder control object over the wireless proximity connection by using the standardized object exchange protocol.

19. The broadcast recorder of claim 17, wherein the communicating means is configured to provide a telecommunications system radio connection with a telecommunications system infrastructure; and
wherein the communicating means is configured to communicate the broadcast recorder control object with a telecommunications system server.

20. The broadcast recorder of claim 17, further comprising:
a request receive means for receiving a request for providing a broadcast recorder control object to the mobile terminal; and
providing means for providing the broadcast recorder control object to the mobile terminal.

21. The broadcast recorder of claim 17, wherein the broadcast control object includes at least one element in a group comprising: a begin mark of the broadcast recorder control object, broadcast type information, a broadcast program identifier, a broadcast channel identifier, broadcast program information, broadcast program timing information, a link to data networks, file history of the broadcast control object, an end mark of the broadcast control object.

22. A system for operating a broadcast recorder, comprising:
a mobile terminal of a wireless telecommunications system, the mobile terminal including: a broadcast recorder control object having object type identification based on which the broadcast recorder control object is identifiable from a plurality of objects; writing means for writing control information into the broadcast recorder control object, the control information including instructions for executing at least one command in a broadcast recorder; and
first communicating means for communicating the broadcast recorder control object to the broadcast recorder by using a wireless connection, the system further comprising a broadcast recorder including: second communicating means for communicating the broadcast recorder control object by using a wireless connection; detecting means for detecting the object type identification; extracting means for extracting the control information from the broadcast recorder control object on the basis of the object type identification; and executing means for executing the at least one command according to the instructions included by the control information.

23. A computer program distribution medium readable by a computer and encoding a computer program of instructions for executing a computer process for operating a broadcast recorder, the process comprising:
writing control information into a broadcast recorder control object having object type identification based on which the broadcast recorder control object is identifiable from a plurality of objects, the control information including instructions for executing at least one command in a broadcast recorder;
communicating the broadcast recorder control object to the broadcast recorder by using a wireless connection;
detecting the object type identification;
extracting the control information from the broadcast recorder control object on the basis of the object type identification; and
executing the at least one command in the broadcast recorder according to the instructions included by the control information.

24. The computer program distribution medium of claim 23, the distribution medium comprising a computer readable medium, a program storage medium, a record medium, a computer readable memory, a computer readable software distribution package, a computer readable signal, a computer readable telecommunications signal, and a computer readable compressed software package.
